(19) United States
(12) Patent Application Publication
(10) Pub. No.: US 2009/0008299 A1
(43) Pub. Date: Jan. 8, 2009

(54) Screen identification device for screening machines

(76) Inventors: Ray Conger, Parma Heights, OH (US); Dwayne Hamilton, Cleveland, OH (US); Justin Smoak, Fremont, CA (US); Jon Griffith, Cleveland, OH (US); Jason Meadwell, Brooklyn Heights, OH (US)

Correspondence Address: CARGILL, INCORPORATED, LAW/24, 15407 MCGINTY ROAD WEST, WAYZATA, MN, 55391, US

(21) Appl. No.: 11/825,130

(22) Filed: Jul. 3, 2007

(51) Int. Cl. B07B 13/14

(52) U.S. Cl. 209/2

(57) ABSTRACT

A method of locating a defective separation screen in a multi-screen system includes providing a plurality of subsets of identifier objects, such as mesh cleaning balls. Each subset has a different identifying characteristic, such as color, from the other subsets and is maintained in at least intermittent contact with each of the screens. When a screen becomes defective, at least one of the subset of the identifier objects associated with the screen is recovered at a location remote from the screen. The location of the defective screen can then be determined based on the identifying characteristic of the recovered identifier object.

### TECHNICAL FIELD

This disclosure relates to screening machines used to sort a variety of material streams based on particle size. Specific arrangements also relate to methods and devices for identifying defective screens in such screening machines.

### BACKGROUND

Screening machines separate and sort out a material stream based on the particle size required. A typical screening machine consists of an opening, or inlet, at an upstream location. This allows for the introduction of the material stream. A screening machine also typically consists of at least one screening deck, sometime also referred to as separation decks. A screening machine having multiple separation decks typically consists of a large mesh screen deck followed with a series of progressively smaller mesh screen decks. Screening machines can have one or more decks based on separation requirements. Decks are normally separated by a divider that provides a vertical space for material to be removed at that level or passed through to the next level. Specific sized material is removed at the different deck levels. The effectiveness of a screening machine is accomplished by the motion of the screen. By design they can rotate, gyrate, shake and/or vibrate.

Based on the material to be screened, the environment, and the size of the screen opening, the screening machines will often require an additional piece of equipment to enhance the screening efficiency and minimize blinding. Blinding or “screen blinding” is when a near size particle is caught in the mesh opening of a screen which does not allow it to pass through and that the motion of the screen is not sufficient to remove it. In these situations an agitation element is added below the screening surface. A piece of equipment often used as an agitation element is a ball (sometimes called a mesh cleaning ball). One or more mesh cleaning balls are placed below the screening surface and are retained in place by the retaining deck. Through the motion of the screening machines, the balls bounce around and free the product lodged in the screen openings.

Screens surfaces eventually become worn due to the constant abrasion of the material passing over and through them and become defective. When this occurs, unwanted particles and material larger than desired can pass through the defective screens resulting in inconsistent and poor quality material. In addition, the balls themselves can eventually pass through a hole or opening in the defective screen. Typically these balls are recovered at a downstream secondary quality material screen. This downstream material screen can be a metal grate or something similar and is often referred to as a “grizzly”. When unwanted particles, larger materials and/or balls are recovered at a downstream location it is an indication that the material is out of specification. Best practices normally provides for the screening machine to be shut down in order to replace the defective screen. The problem faced when these conditions occur is that each screening machine can contain a plurality of screen enclosures and screens. It is typically not readily known which particular screen is the defective or broken screen. Moreover, a screening machine is often used in conjunction with other screening machines, either serially or in parallel, resulting in an even greater plurality of screen enclosures and screens. Trying to determine which specific screen in which screening machine is defective can require a significant amount of labor time spent a significant loss of production time. It also increases the safety risk as more time is needed to open up the screening machines, remove and inspect the screen enclosures, and replace the screens, which can be large, bulky, and difficult to handle.

Thus, there exists a need in the art to more quickly and effectively determine which specific screening surface is defective in order to reduce labor hours, to keep to a minimum lost production time, to improve safety for employees, and to ensure a more consistent product quality.

### SUMMARY OF THE DISCLOSURE

The present disclosure relates to a method and device of identifying a condition in at least one of a plurality of screens. Specific configurations allow a faster and more efficient method of identifying a condition in the screening machines through the use of identifying objects that have unique characteristics. In one aspect, a method for identifying the condition includes selecting a plurality of identifier objects with at least a first one of the identifier objects comprising at least one different characteristic from at least a second one of the identifier objects, maintaining the first one of the identifier object adjacent to, and in at least intermittent contact with, the at least one of the plurality of screens, maintaining the second one of the identifier object adjacent to, and in at least intermittent contact with, at least another one of the plurality of screens, receiving at least one of the first and second identifier objects at a location remote to the first and second ones of the plurality of screens after the condition is satisfied at least one of the first and second ones of the plurality of screens, and determining the screen where the condition is satisfied based on the at least one characteristic.

In another aspect of the present disclosure, a screening system for sorting particulate products according to size comprises a plurality of screen enclosures, and a plurality of identifier objects located in at least one of the screen enclosures, at least one of the plurality of identifier objects having at least one identifying characteristic different from at least another one of the plurality of identifier objects.

In another aspect of the present disclosure, a kit is provided for identifying at least one subset of screens in a plurality of screen enclosures. The kit comprises: a plurality of identifier objects, at least one of the identifying objects having at least one identifying characteristic different from at least another one of the plurality of identifier objects, and a description of at least a correspondence between the at least one identifying characteristic of each of the identifier objects and the subset of screen enclosures.

### BRIEF DESCRIPTION OF THE DRAWINGS

FIG. 1 is a schematic illustration of a configuration, in which a plurality of mesh cleaning balls of different characteristics, such as colors, are disposed in respective screen enclosures, according to one aspect of the present disclosure.

FIG. 2 is a schematic illustration of a configuration, in which a plurality of mesh cleaning balls of different characteristics, such as colors, are disposed in respective screening machines operating in parallel, according to another aspect of the present disclosure.

FIG. 3 is a schematic illustration of a configuration, in which a plurality of mesh cleaning balls of different characteristics, such as colors, are disposed in respective screening machines operating in series, according to a further aspect of the present disclosure.

### DETAILED DESCRIPTION

### I. Overview

This disclosure relates to screening machines used to sort a variety of material streams based on particle size.

Screening machines are currently used in a variety of industries to separate and sort out a material stream based on the particle size of the product. One example of a commercially available screening machine is that sold by Rotex® such as their Megatex™ screener. These machines can be used in a variety of industries to separate material, including but not limited to agricultural material, mined material, food material, etc. Examples of material streams that can be separated and sorted include but is not limited to salt, flour, sugar, soybeans, oilseeds, grains, corn, barley, wheat, ore, gold, coal, fertilizers and metals.

A typical screening machine fitted with mesh cleaning balls includes at least one screen enclosure. The screen enclosure typically consists of at least one upper screening surface and a lower ball retainer screen (sometimes known as “retaining deck”) that are vertically separated by a framed member. Rubber balls (sometimes called “mesh cleaning balls”) can be placed inside of the screen enclosure between the upper screening surface and the ball retaining screen. The ball retaining screen typically has larger openings than the screening surface. As the material is introduced upstream into the screening machine, the material or particles of certain size and/or shape may clog (“blind”) the individual screen openings of the screening surface. Through the motion of the screening machines, the mesh cleaning balls bounce around and free the material lodged in the blinded screen openings. The retaining deck is typically constructed and divided so as to enhance the cleaning action of the mesh cleaning balls by maintaining the action of them over the entire surface. When a screen becomes defective from wear such that an opening larger than the mesh cleaning balls develops in the screening surface, or a screen enclosure that holds the balls fails or becomes loose, at least some of the mesh cleaning balls in the enclosure may pass through the defective screens or screen enclosures and be recovered downstream. With the traditional practice, the mesh cleaning balls do not have characteristics that are associated with any subset of the screen enclosures. Thus, when one or more mesh cleaning balls are recovered downstream, an operator is alerted to the fact that one or more screens have become defective but is not able to readily narrow the defective screen or screens to a particular subset of the screen enclosures. Work stoppage and inspection of all or a large number of screen enclosures are often required.

The invention allows a faster and more efficient method of identifying a condition in the screening machines through the use of identifying objects that have different characteristics, such as colors or other indicia, from each other.

### II. Example Processes and Configurations

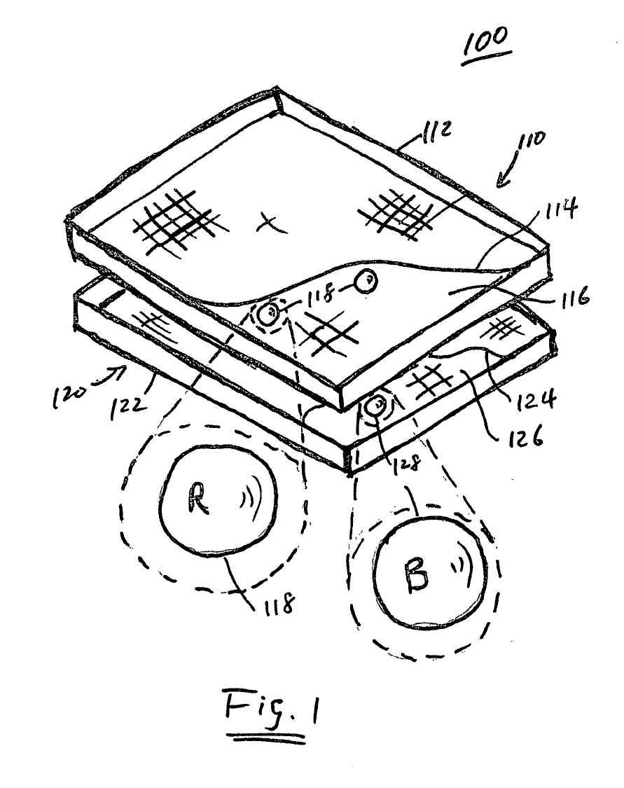

A process and system for identifying defective screen enclosures using identifier objects according to one aspect of the present disclosure is now described with reference to an example in FIG. 1.

A portion 100 of a screening machine in this example includes at least two screen enclosures 110, 120. The two enclosures in this particular example are substantially parallel to each other but need not be. The upper enclosure 110 includes an enclosure frame 112, an upper screen 114 (partially cut out in the drawing to more clearly show interior space of the upper enclosure 110) and a lower ball retainer screen 116. Similarly the lower enclosure 120 includes an enclosure frame 122, an upper screen 124 (partially cut out in the drawing to more clearly show interior space of the upper enclosure 120) and a lower ball retaining screen 126. In this example, the upper screen 114 of the upper enclosure 110 has smaller openings than the lower ball retaining screen 116; the upper screen 124 of the lower enclosure 120 has smaller openings than the lower ball retaining screen 126.

As further shown schematically shown in FIG. 1, one or more identifier objects are placed in the upper enclosure 110, and one or more identifier objects are placed in the lower enclosure 120. In this example, the identifier objects are mesh cleaning balls 118 and 128, respectively. The identifier objects in one enclosure have at least one different characteristic from the identifier objects in another enclosure. For example, in the example shown in FIG. 1, the mesh cleaning balls 118 and 128 have different colors, with red balls (labeled as “R” in the drawing) in the upper enclosure 110 and blue balls (labeled as “B” in the drawing) in the lower enclosure 120. In another example configuration, other visual identifying characteristics can be used. Examples include patterns, including lettering and symbols. Thus, the identifying characteristic of each mesh cleaning ball is associated with a screen enclosure.

In operation, as the screen enclosures 110 and 120 are moved by one or more screening machines, which themselves can also move, the mesh cleaning balls 118 bounce between the upper screen 114 and ball retaining screen 116. Similarly, the mesh cleaning balls 128 bounce between the upper screen 124 and ball retaining screen 126. Each mesh cleaning ball is thus maintained in at least intermittent contact with the screening surface (114 or 124) of the enclosure in which the ball is kept.

When an screening surface, for example the upper screen 114 in the upper enclosure 110, become defective such that a perforation large enough for a mesh cleaning ball (e.g., ball 118) to pass, one or more mesh cleaning balls can pass through the screen and appear in the material downstream. An operator can quickly determine the defective screen enclosure based on the identifying characteristic. For example, for the configuration shown in FIG. 1, if a mesh cleaning ball collected downstream is red, the operator can readily determine that the upper enclosure 110 is defective.

According to one aspect of the present disclosure, the identifier objects are mesh cleaning balls of distinctive colors from each other, and the color or colors of each ball is distributed throughout the ball. In other aspects of the disclosure, the color or colors, or other visual identifying characteristics, of each ball is distributed at least partially throughout a finite depth inward from the surface of the ball. Thus, the visual identifying characteristics of each ball remain discernable even after the ball has been reduced in size through wear. Instead of, or in addition to, color or other visual identifying characteristics, other identifying characteristics can be used for identifying defective enclosure. For example, according an aspect of the present disclosure, at least one radio-frequency (RF) transponder configured to transmit an RF signal is incorporated into each mesh cleaning ball. The RF signals for balls for different screen enclosures can be different, for example, in frequency or codes modulated into the RF signals.

In a further aspect of the present disclosure, a kit is provided for identification of defective screen enclosures. The kit in one example configuration includes a plurality of identifier objects, such as mesh cleaning balls, in which at least one identifier object has a different identifying characteristics, such as color, from at least another one of the identifier objects. The kit further includes a description, such as an instruction sheet or instructional video that describes a correspondence between the identifying characteristic of each of the identifier objects and at least a subset of screen enclosures. Alternatively or additionally, the description can also instruct the user to associate one or more identifying characteristics with a subset of screen enclosures.

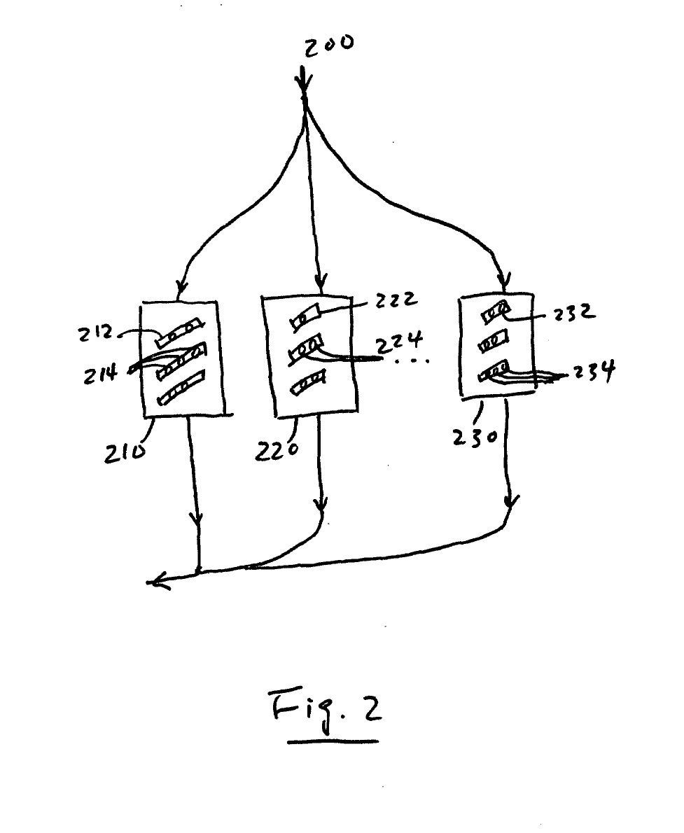

Referring now to FIG. 2, according to another aspect of the present disclosure, identifier objects with different identifying characteristics can be used to identify a defective screening machine from a plurality of screening machines 210, 220, 230 operating in parallel. That is, material 200 is fed from up stream and divided into sub-streams, each of which is fed through a screening machine. The screened sub-streams are then combined according to size range. In one example configuration, identifier objects (214, 224 or 234) placed in the screen enclosures (212, 222 or 232) in each screening machine (210, 220 or 230) have one or more identifying characteristics different from the identifier objects placed in the screen enclosures in at least another one of the screening machines. Thus, if an identifier object, such as a color-coded mesh cleaning ball is received downstream of the screening machines, the screening machine with a defective screen enclosure can be identified by the color of the ball. The screening machine with the defective screen enclosure can thus be interrupted to replace the defective screen, while the other screening machines can continue to operate.

In addition, identifier objects of different identifying characteristics can be placed in different screen enclosures in each screening machine and used as described above in connection with FIG. 1. According to one aspect of the present disclosure, one or more identifying objects with a unique identifying characteristic or unique set of identifying characteristics are placed in, and associated with, each screen enclosure.

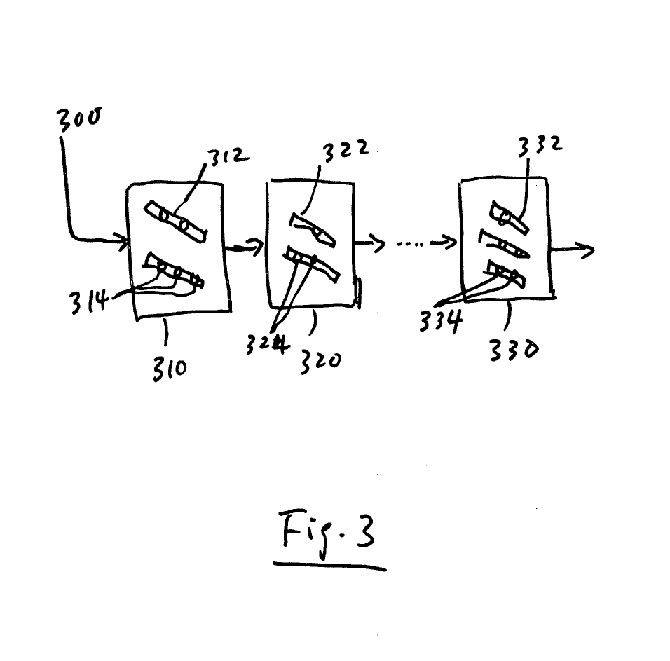

Referring now to FIG. 3, according to another aspect of the present disclosure, identifier objects with different identifying characteristics can be used to identify a defective screening machine from a plurality of screening machines 310, 320, 330 operating in series. That is, a material 300 is feed successively through the screening machines. The use of identifier objects (314, 324 or 334) with unique identifying characteristics to identify defective screen enclosure (312, 322 or 332) or screening machine (310, 320 or 330), or both, is similar to what has been described above for screening machines operating in parallel and in connection with FIG. 1. In another aspect of the disclosure, the identifying objects can be intercepted at points between two successive screening machines.

Additionally, identifier objects with unique identifying characteristics can also be used in systems with combinations of serial and parallel arrangements of screening machines.

### III. Summary

Thus, according to the present disclosure, mesh cleaning balls or other identifier objects with unique identifying characteristics, such as colors, are placed in screening enclosures to provide ready identification of defective screens by inspecting the identifying objects received downstream. Productivity and safety can be significantly improved in reduced screening machine downtime and reduce number of screen enclosures or machines that must be inspected.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method of identifying a condition of at least one of a plurality of screens, the method comprising:
selecting a plurality of identifier objects with at least a first one of the identifier objects comprising at least one different characteristic from at least a second one of the identifier objects;
maintaining the first one of the identifier objects in at least intermittent contact with the at least one of the plurality of screens;
maintaining the second one of the identifier objects in at least intermittent contact with at least another one of the plurality of screens;
receiving at least one of the first or second identifier objects at a location remote to the first and second of the plurality of screens after the condition is satisfied at least one of the first and second ones of the plurality of screen enclosures; and
determining the screen where the condition is satisfied based on the at least one characteristic of the at least one of the first or second identifier objects received at the remote location.

2. The method of claim 1, wherein selecting a plurality of identifier objects comprises selecting a plurality of identifier objects with at least a first one of the identifier objects having at least one different visual characteristic from at least a second one of the identifier objects.

3. The method of claim 2, wherein the visual characteristic is color.

4. A method for identifying a defective screen among a plurality of screens, the method comprising:
placing in each of a plurality of screen enclosures, wherein said screen enclosure comprises at least two screens substantially parallel to each other, at least one identifier object having at least one identifying characteristic different from at least an identifier object placed in another one of the plurality of screen enclosures;
receiving at least one of the identifier objects from the plurality of screen enclosures after at least one of the plurality of screens is defective; and
identifying at least a subset of the plurality of screen enclosures as having at least one defective screen based on the identifying characteristic of the received identifier object.

5. The method of claim 4, wherein placing in each of the plurality of screen enclosures at least one identifier object comprises placing in each of the plurality of screen enclosures at least one ball.

6. The method of claim 5, wherein placing in each of the plurality of screen enclosures at least one ball comprises placing in each of the plurality of screens at least one ball having a different visual characteristic than at least one ball placed in another one of the plurality of screen enclosures.

7. The method of claim 6, wherein placing in each of the plurality of screens at least one ball comprises placing in each of the plurality of screen enclosures at least one ball having a different color than at least one ball placed in another one of the plurality of screen enclosures.

8. The method of claim 5, further comprising bouncing the balls against their respective screens to unclog the screens.

9. The method of claim 4, further comprising screening at least one particulate product with at least a subset of the plurality of screens in series.

10. The method of claim 4, further comprising screening at least one particulate product with at least a subset of the plurality of screen enclosures in parallel.

11. The method of claim 4, further comprising moving at least a portion of a particulate product from an upstream location to a downstream location through the plurality of screen enclosures; wherein receiving at least one of the identifier objects from the plurality of screen enclosures comprises receiving the identifier objects at the downstream location.

12. The method of claim 4, wherein identifying at least a subset of the plurality of screen enclosures as having at least one broken screen comprises identifying the broken screen based on the identifying characteristic of the received identifier object.

13. The method of claim 4, wherein placing on each of the plurality of screen enclosures at least one identifier object comprises placing on each of the plurality of screen enclosures at least one identifier object incorporating at least a radio-frequency (RF) transponder configured to transmit an RF signal different from at least one identifier object placed on another one of the plurality of screen enclosures.

14. The method of claim 12, wherein placing on each of the plurality of screen enclosures at least one identifier object comprises placing on each of the plurality of screen enclosures at least one ball.

15. A kit for identifying at least one subset of screens in a plurality of screen enclosures, the kit comprising:
a plurality of identifier objects, at least of the identifying objects having at least one identifying characteristic different from at least another one of the plurality of identifier objects; and
a description of at least a correspondence between the at least one identifying characteristic of each of the identifier objects and the subset of screen enclosures.

16. The kit of claim 15, wherein the identifying characteristic comprises color.

17. The kit of claim 15, wherein the identifier objects comprise balls.

18. A screening system for sorting particulate products according to size, the system comprising:
a plurality of screen enclosures; and
a plurality of balls,
each of the plurality of the screen enclosures containing at least one of the plurality of balls,
the at least one of the plurality of balls in each screen enclosure having at least one identifying characteristic different from the at least one of the plurality of balls in at least another one of the plurality of screen enclosures.

19. The system of claim 18, wherein the identifying characteristic is color.
